(19) United States
(12) Patent Application Publication
(10) Pub. No.: US 2018/0188434 A1
(43) Pub. Date: Jul. 5, 2018

(54) LIGHT DIFFRACTION APPARATUS, DISPLAY SUBSTRATE, TOUCH SUBSTRATE AND TOUCH DISPLAY APPARATUS, AND METHOD OF MODULATING IMAGE DISPLAY LIGHT INTENSITY

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Huishun Chen, Beijing (CN); Wei Li, Beijing (CN); Kaixuan Wang, Beijing (CN); Xiaojuan Wu, Beijing (CN); Li Ma, Beijing (CN); Xiaoqing Peng, Beijing (CN); Zijing Zhang, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/533,728

(22) PCT Filed: Nov. 30, 2016
(86) PCT No.: PCT/CN2016/107974

§ 371 Date: Jun. 7, 2017

(30) Foreign Application Priority Data
Jun. 24, 2016 (CN) 201610482949.9

(51) Int. Cl. G02B 5/32; G02B 27/44

(52) U.S. Cl. CPC G02B 5/32; G06F 3/041; G02F 2201/305; G02B 27/44

(57) ABSTRACT

The present application discloses a light diffraction apparatus coupled to a display substrate for diffracting light emitted from a subpixel of the display substrate. The light diffraction apparatus includes a grating element including a photorefractive material having a holographic grating recorded thereon. The grating element is configured to diffract the light emitted from the subpixel upon application of an electrical field.

### CROSS-REFERENCE TO RELATED APPLICATION

This application claims priority to Chinese Patent Application No. 201610482949.9, filed Jun. 24, 2016, the contents of which are incorporated by reference in the entirety.

### TECHNICAL FIELD

The present invention relates to display technology, more particularly, to a light diffraction apparatus, a display substrate, a touch substrate, a touch display apparatus, and a method of modulating image display light intensity in a display panel having the light diffraction apparatus.

### BACKGROUND

With the rapid development in display technology in recent years, consumers continue to demand higher image display quality. For example, display apparatuses having higher brightness, a wider viewing angle, and a high contrast level at wider viewing angles have become the focus of research and development in display technology. Display apparatuses that would benefit from having a wider viewing angle include a television, a mobile phone, a tablet computer, etc.

### SUMMARY

In one aspect, the present invention provides a light diffraction apparatus coupled to a display substrate for diffracting light emitted from a subpixel of the display substrate, comprising a grating element comprising a photorefractive material having a holographic grating recorded thereon, configured to diffract the light emitted from the subpixel upon application of an electrical field.

Optionally, the holographic grating has a pattern configured to generate a diffracted light so that light exiting from the light diffraction apparatus has a more symmetrical light intensity distribution with respect to a plane normal to the display substrate as compared to the light emitted from the subpixel.

Optionally, the grating element having the holographic grating is configured to diffract a first portion of light emitted from the subpixel along a first direction: a second portion of light emitted from a same subpixel along a second direction exits the display substrate without being diffracted by any holographic grating: the first portion of light emitted from the subpixel has an intensity higher than that of the second portion of light emitted from the same subpixel; the first portion of light emitted from the subpixel is diffracted into a first portion of the diffracted light transmitting substantially along the first direction and a second portion of the diffracted light transmitting substantially along the second direction; and the first direction and the second direction are substantially mirror symmetrical with respect to the plane normal to the display substrate.

Optionally, the grating element comprises a first portion having the holographic grating and a second portion absent of any holographic grating; and the second portion of light emitted from the same subpixel along the second direction transmits through the second portion of the grating element without being diffracted.

Optionally, a first portion of grating element having the holographic grating is configured to diffract a first portion of light emitted from the subpixel along a first direction; a second portion of grating element having the holographic grating is configured to diffract a second portion of light emitted from a same subpixel along a second direction; the first portion of light emitted from the subpixel has an intensity higher than that of the second portion of light emitted from the same subpixel; the first portion of light emitted from the subpixel is diffracted into a first portion of the diffracted light transmitting substantially along the first direction and a second portion of the diffracted light transmitting substantially along the second direction; the second portion of light emitted from the same subpixel is diffracted into a third portion of the diffracted light transmitting substantially along the second direction and a fourth portion of the diffracted light transmitting substantially along the first direction; and the first direction and the second direction are substantially mirror symmetrical with respect to the plane normal to the display substrate.

Optionally, a grating periodicity Λ of the holographic grating is defined by Λ=λγ/(2n sin θγ); n is a positive integer, λγ is a wavelength of a diffracted light, θγ is a sum of a first angle between a light incident to the grating element and a normal of an incident surface of the grating element and a second angle between the normal and a grating vector.

Optionally, the light diffraction apparatus further comprises a first electrode and a second electrode coupled to a first side and a second side of the grating element, respectively, configured to apply the electrical field to the grating element, the first side and the second side being opposite to each other; and a controller coupled to the first electrode and the second electrode, configured to provide a voltage signal to the first electrode and the second electrode for generating the electrical field.

Optionally, the first electrode and the second electrode are made of a transparent electrode material.

Optionally, the first side and the second side of the grating element are substantially perpendicular to the display substrate.

Optionally, a side of the first electrode facing the first side has a substantially the same dimension as the first side; and a side of the second electrode facing the second side has a substantially the same dimension as the second side.

Optionally, a cross-section of the grating element has a square shape or a rectangular shape.

In another aspect, the present invention provides a method of fabricating a touch substrate, comprising forming a touch electrode layer on a base substrate; forming a photorefractive material layer on a side of the touch electrode layer distal to the base substrate; patterning the photorefractive material layer; and forming a holographic grating in the photorefractive material layer thereby forming a grating element comprising a photorefractive material having a holographic grating recorded thereon.

Optionally, the method further comprises forming an electrode layer comprising a first electrode and a second electrode on a side of the touch electrode layer distal to the base substrate; wherein the first electrode and the second electrode are formed to be coupled to a first side and a second side of the grating element, respectively; the first side and the second side of the grating element are substantially perpendicular to the display substrate; a side of the first electrode facing the first side has a substantially the same dimension as the first side of the grating element; and a side of the second electrode facing the second side has a substantially the same dimension as the second side of the grating element.

In another aspect, the present invention provides a method of modulating image display light intensity in a display panel, comprising diffracting light emitted from a subpixel of the display substrate to generate a diffracted light so that light exiting from the display panel has a more symmetrical light intensity distribution with respect to a plane normal to the display substrate as compared to the light emitted from the subpixel.

Optionally, the method comprises diffracting a first portion of light emitted from the subpixel along a first direction into a first portion of the diffracted light transmitting substantially along the first direction and a second portion of the diffracted light transmitting substantially along the second direction; transmitting a second portion of light emitted from a same subpixel along a second direction without being diffracted by any holographic grating; the first portion of light emitted from the subpixel has an intensity higher than that of the second portion of light emitted from the same subpixel; and the first direction and the second direction are substantially mirror symmetrical with respect to the plane normal to the display substrate.

Optionally, the method comprises diffracting a first portion of light emitted from the subpixel along a first direction into a first portion of the diffracted light transmitting substantially along the first direction and a second portion of the diffracted light transmitting substantially along the second direction; and diffracting a second portion of light emitted from a same subpixel along a second direction into a third portion of the diffracted light transmitting substantially along the second direction and a fourth portion of the diffracted light transmitting substantially along the first direction; wherein the first portion of light emitted from the subpixel has an intensity higher than that of the second portion of light emitted from the same subpixel; and the first direction and the second direction are substantially mirror symmetrical with respect to the plane normal to the display substrate.

In another aspect, the present invention provides a display apparatus comprising the light diffraction apparatus described herein or fabricated by a method described herein.

In another aspect, the present invention provides a touch substrate comprising a light diffraction apparatus described herein or fabricated by a method described herein.

In another aspect, the present invention provides a touch display apparatus, comprising a touch substrate; and a light diffraction apparatus described herein or fabricated by a method described herein; wherein the light diffraction apparatus is at least partially integrated into the touch substrate.

Optionally, the touch substrate comprises a plurality of sub-regions, the light diffraction apparatus comprises a plurality of light diffraction apparatuses; and each of the plurality of light diffraction apparatuses is in one of the plurality of sub-regions.

### BRIEF DESCRIPTION OF THE FIGURES

The following drawings are merely examples for illustrative purposes according to various disclosed embodiments and are not intended to limit the scope of the present invention.

FIG. 1A is a diagram illustrating a light path in a light diffraction apparatus when no electrical field is applied thereon in some embodiments according to the present disclosure.

FIG. 1B is a diagram illustrating a light path in a light diffraction apparatus when an electrical field is applied thereon in some embodiments according to the present disclosure.

FIG. 2A is a diagram illustrating a light path in a light diffraction apparatus when no electrical field is applied thereon in some embodiments according to the present disclosure.

FIG. 2B is a diagram illustrating a light path in a light diffraction apparatus when an electrical field is applied thereon in some embodiments according to the present disclosure.

FIG. 3 is a diagram illustrating the structure of a touch display apparatus in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

Conventional display apparatuses have limited viewing angles. At large viewing angles, the conventional display apparatuses tend to quickly lose contrast and become hard to read. The range of viewing angles is typically determined by several factors. One of the most important factors is brightness of emitting light at large viewing angles. For example, conventional twisted nematic type display apparatuses quickly lose emitting light brightness as the viewing angle increases. Advanced super dimension switch type display apparatuses have much larger viewing angles as compared to the twisted nematic type display apparatuses, however, brightness of emitting light at larger viewing angles in the advanced super dimension switch type display apparatuses is still limited by various factor.

Accordingly, the present invention provides, inter alia, a light diffraction apparatus, a display substrate, a touch substrate, a touch display apparatus, and a method of modulating image display light intensity in a display panel having the light diffraction apparatus, that substantially obviate one or more of the problems due to limitations and disadvantages of the related art. In one aspect, the present disclosure provides a light diffraction apparatus coupled to a display substrate for diffracting light emitted from a subpixel of the display substrate. In some embodiments, the light diffraction apparatus includes a grating element including a photorefractive material having a holographic grating recorded thereon, configured to diffract the light emitted from a subpixel upon application of an electrical field. Optionally, the grating element is a photorefractive crystal. The holographic grating has a pattern configured to generate a diffracted light so that light exiting from the light diffraction apparatus has a more symmetrical light intensity distribution with respect to a plane normal to the light emitting surface of the display substrate as compared to the light emitted from the subpixel. By making light intensity distribution more uniform at various emitting directions, a much larger viewing angle can be achieved in a display apparatus having the present light diffraction apparatus.

Examples of photorefractive materials include, but are not limited to, inorganic crystals such as BaTiO₃, LiNbO₃, Bi₁₂SiO₂₀, Bi₁₂GeO₂₀, KNbBO₃, InP, GaAs, GaP, and CdTe, and organic photorefractive materials such as organic crystals and photorefractive polymers (see, e.g., U.S. Pat. No. 5,064,264).

In conventional display apparatuses, light emitting brightness and light intensity distribution at large viewing angles are difficult to control. Taking light emitted from a subpixel as an example, typically the light emitted from a subpixel has an asymmetrical light intensity distribution with respect to the plane normal to the light emitting surface of the display panel. By having the present light diffraction apparatus, light emitting brightness and light intensity distribution at large viewing angles can be improved.

In one example, the present light diffraction apparatus partially covers the light emitting surface of a subpixel to uniformize light intensity distribution at various emitting directions, thereby increasing the viewing angle of the display apparatus. For example, light emitted from the subpixel at a first direction and a second direction having a substantial mirror symmetry to the first direction with respect to a plane normal to light emitting surface of the display substrate may have different intensities. Optionally, a first portion of light emitted from the subpixel along the first direction has an intensity higher than that of a second portion of light emitted from the same subpixel along the second direction. In some embodiments, the first portion of light emitted from the subpixel along the first direction is diffracted by the grating element having the holographic grating, a second portion of light emitted from a same subpixel along a second direction exits the display substrate without being diffracted; the first portion of light emitted from the subpixel is diffracted into a first portion of the diffracted light transmitting substantially along the first direction and a second portion of the diffracted light transmitting substantially along the second direction. Optionally, the grating element comprises a first portion having the holographic grating and a second portion absent of any holographic grating, and the second portion of light emitted from the same subpixel along the second direction transmits through the second portion of the grating element without being diffracted. Thus, light intensity along the second direction is increased by the second portion of the diffracted light, uniformizing light intensity distribution at opposite emitting directions.

In one example, the present light diffraction apparatus covers the entire light emitting surface of a subpixel to uniformize light intensity distribution at various emitting directions, thereby increasing the viewing angle of the display apparatus. For example, light emitted from the subpixel at a first direction and a second direction having a substantial mirror symmetry to the first direction with respect to a plane normal to the light emitting surface of the display substrate may have different intensities. Optionally, a first portion of light emitted from the subpixel along the first direction has an intensity higher than that of a second portion of light emitted from the same subpixel along the second direction. In some embodiments, the first portion of light emitted from the subpixel along the first direction is diffracted by a first portion of grating element having the holographic grating, the second portion of light emitted from a same subpixel along the second direction is diffracted by a second portion of grating element having the holographic grating, the first portion of light emitted from the subpixel is diffracted into a first portion of the diffracted light transmitting substantially along the first direction and a second portion of the diffracted light transmitting substantially along the second direction, and the second portion of light emitted from the same subpixel is diffracted into a third portion of the diffracted light transmitting substantially along the second direction and a fourth portion of the diffracted light transmitting substantially along the first direction. Optionally, the first portion of the diffracted light and the second portion of the diffracted light have a substantially the same intensity. Optionally, the third portion of the diffracted light and the fourth portion of the diffracted light have a substantially the same intensity. Light transmitted from the display panel along the first direction is a combination of the first portion of the diffracted light and the fourth portion of the diffracted light, and light transmitted from the display panel along the second direction is a combination of the second portion of the diffracted light and the third portion of the diffracted light. Thus, light intensities along the first direction and the second direction are evened out by redistributing light along the first direction and the second direction from the subpixel.

In some embodiments, the holographic multi-grating structure in the grating element may be recorded using a laser writing light according to the equation (1):

Λ=λ_{w}/(2n sin θ_{w}) (1);

wherein Λ is the grating periodicity, n is a positive integer, λ_{w} is a wavelength of a diffracted light, θ_{w} is a sum of a first angle between a writing light incident to the grating element and a normal of an incident surface of the grating element and a second angle between the normal and a grating vector. The grating periodicity may be adjusted by changing the wavelength of the writing light, and an included angle between two writing light beams. A maximum diffraction intensity of each grating may be controlled by writing duration, thereby forming a multi-grating structure that diffracts light uniformly. According to Bragg's law, only a reading light having a wavelength that meets the following condition set forth in the equation (2) will be diffracted by the grating structure:

Λ=λ_{w}/(2n sin θ_{w})=λ_{γ}/(2n sin θᵣ) (2);

wherein λγ is a wavelength of a diffracted light, θγ is a sum of a first angle between a light incident to the grating element and a normal of an incident surface of the grating element and a second angle between the normal and a grating vector.

Electrically-controlled diffraction efficiency of the grating element can be calculated according to the equation (3):

$$η = {sin}^{2} ( \frac{π L}{{λ ( cos {θ}_{w} cos {θ}_{r} )}^{1 / 2}} {s}_{eff} {n}_{0}^{3} {E}_{sc} {E}_{0} ) ; \qquad ( 3 )$$

When the electrical field E₀ applied to two sides of the grating element is zero, the incident light transmits through the grating element without diffraction. When the electrical field E₀ applied to two sides of the grating element is larger than zero, an incident light having a wavelength satisfying the equation (2) will be diffracted. The diffraction efficiency increases as the electrical field increases, a maximum diffraction efficiency over 90% may be achieved. By controlling the applied electrical field, a plurality of incident light having a plurality of wavelengths transmitted along a same direction may be diffracted along a same direction. Similarly, by controlling the applied electrical field, a plurality of incident light having a plurality of wavelengths transmitted along a plurality of directions may be diffracted along a same direction. Thus, a pattern of the holographic multi-grating structure in the grating element may be recorded based on the parameters in each subpixel, including the range of light wavelengths, light intensity, propagating directions, and the like, thereby controlling diffracted light intensity distribution at various viewing angles.

In some embodiments, each grating element covers a single subpixel. In some embodiments, each grating element covers a plurality of subpixels. For example, the display panel may be divided into a plurality of sub-regions. Optionally, each sub-region includes a plurality of subpixels having similar light intensity distribution characteristics. By having each grating element covering a plurality of subpixels, the fabricating process may be simplified.

In some embodiments, the light diffraction apparatus further includes an electrode structure configured to apply an electrical field to the grating element. Optionally, the electrode structure includes a first electrode and a second electrode coupled to a first side and a second side of the grating element, respectively. Optionally, the first side and the second side are opposite to each other. Optionally, the first side and the second side of the grating element are substantially perpendicular to the display substrate. Optionally, the first electrode and the second electrode are made of a transparent electrode material.

In some embodiments, the grating element is sandwiched between the first electrode and the second electrode. Optionally, a side of the first electrode facing the first side of the grating element has a substantially the same dimension as the first side of the grating element, and a side of the second electrode facing the second side of the grating element has a substantially the same dimension as the second side of the grating element. Optionally, the side of the first electrode facing the first side of the grating element and the side of the second electrode facing the second side of the grating element are substantially perpendicular to the display substrate. By having this design, the contacting surface between the electrode structure and the grating element can be maximized, and the strength of the electrical field applied to the grating element can be maximized, enhancing the effects of the light diffraction of the light diffraction apparatus.

Optionally, a cross-section of the grating element has a square shape or a rectangular shape. Optionally, a cross-section of the grating element has a parallelogram shape or a trapezoidal shape. Optionally, the cross-section is a cross-section along a plane parallel to the light emitting surface of the display substrate. Optionally, the cross-section is a cross-section along a plane perpendicular to the light emitting surface of the display substrate. Optionally, cross-sections of the grating element along a plane parallel to the light emitting surface and along a plane perpendicular to the light emitting surface have a square shape or a rectangular shape. Optionally, a cross-section of the grating element along a plane parallel to the light emitting surface has a parallelogram shape or a trapezoidal shape, and a cross-section of the grating element along a plane perpendicular to the light emitting surface has a square shape or a rectangular shape.

In some embodiments, the light diffraction apparatus further includes a controller coupled to the first electrode and the second electrode, configured to provide a voltage signal to the first electrode and the second electrode for generating the electrical field. Optionally, the controller is an integrated circuit or a chip with a processor.

In some display panels, or at least in some regions of some display panels, light intensity of light emitted from each of such subpixels varies over various different light emitting directions. Accordingly, in some embodiments, the grating element corresponding to each of such subpixels includes a holographic grating configured to diffract substantially all light emitted from the subpixel, i.e., the grating element includes a holographic grating in areas corresponding to the entire light emitting side of the subpixel, thereby uniformizing the light intensity distribution over the entire subpixel area. In some display panels, or at least in some regions of some display panels, light intensity of light emitted along a certain range of light emitting directions from each of such subpixels is lower (or higher) than that long other light emitting directions. Accordingly, in some embodiments, the grating element corresponding to each of such subpixels includes a first portion having a holographic grating and a second portion without a holographic grating. The light emitted from the subpixel (prior to entering the grating element) includes a first portion of light transmitted along a first direction and a second portion transmitted along a second direction, the first portion having a higher intensity than the second portion. The second portion of light transmitted along the second direction transmits through the second portion of the grating element without being diffracted. The first portion of light transmitted along the first direction enters the first portion of the grating element, and is diffracted into a first portion of diffracted light substantially along the first direction and a second portion of diffracted light substantially along the second direction. By having this design, the light intensity along the second direction is increased. Depending on the types of the display panels and the types of regions of the display panels, the grating elements in the light diffraction apparatus can be designed to have a holographic grating configured to diffract substantially all light emitted from the subpixel, or designed to have a holographic grating configured to diffract a portion of the light emitted from the subpixel.

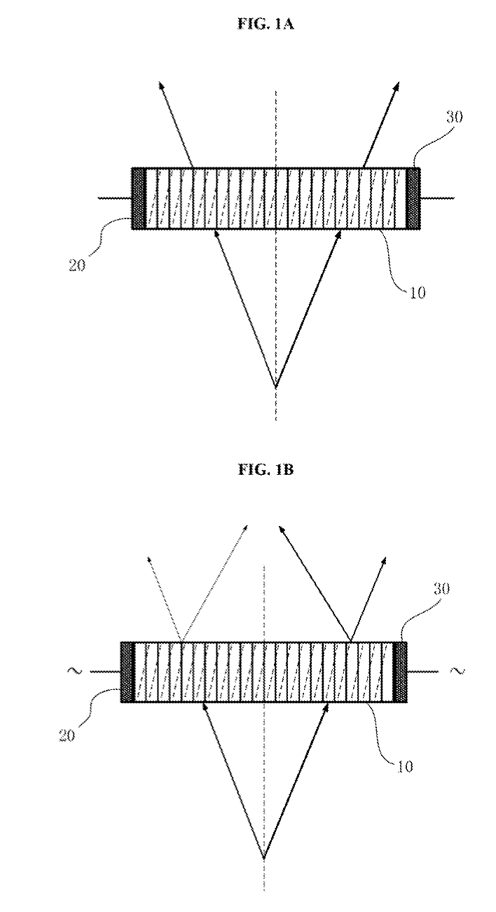

FIG. 1A is a diagram illustrating a light path in a light diffraction apparatus when no electrical field is applied thereon in some embodiments according to the present disclosure. FIG. 1B is a diagram illustrating a light path in a light diffraction apparatus when an electrical field is applied thereon in some embodiments according to the present disclosure. Referring to FIGS. 1A and 1B, the holographic grating in some embodiments is configured to diffract substantially all light emitted from a subpixel. In FIG. 1A, no electrical field is applied to the grating element 10 through the first electrode 20 and the second electrode 30, light emitted from the subpixel travels through the grating element 10 along substantially the same direction. Light intensity along the first direction (leaning left) is higher than that along the second direction (leaning right). Light intensity distribution is non-uniform over various viewing angles. In FIG. 1B, an electrical field is applied to the grating element 10 through the first electrode 20 and the second electrode 30. Light having a wavelength satisfies the Bragg's law is diffracted by the grating element 10. As shown in FIG. 1B, light emitting from the subpixel along the first direction (leaning left) is diffracted into a first portion of the diffracted light transmitting substantially along the first direction and a second portion of the diffracted light transmitting substantially along the second direction. Light emitting from the subpixel along the second direction (leaning right) is diffracted into a third portion of the diffracted light transmitting substantially along the second direction and a fourth portion of the diffracted light transmitting substantially along the first direction. Prior to entering the grating element 10, light emitting from the subpixel along the first direction has an intensity higher than that of light emitting from the subpixel along the second direction. The first direction and the second direction are substantially mirror symmetrical with respect to the plane normal to the light emitting surface of the display substrate. After the light being diffracted by the grating element, the light travelling along the first direction (a sum of the first portion and the fourth portion of the diffracted light) has an intensity substantially the same as the light travelling along the second direction (a sum of the second portion and the third portion of the diffracted light). Thus, the light intensity of light travelling along the second direction is compensated by the diffraction effects of the grating element 10, resulting in a more uniform light intensity distribution over various light emitting directions.

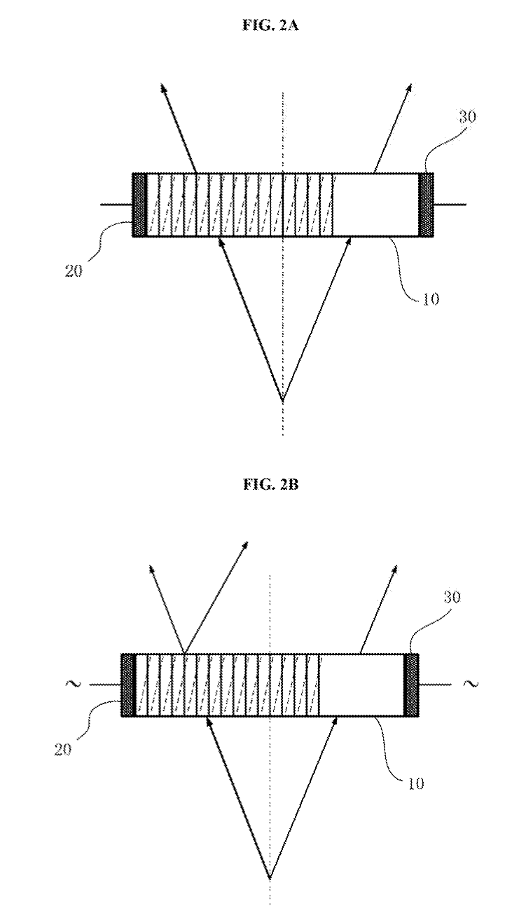

FIG. 2A is a diagram illustrating a light path in a light diffraction apparatus when no electrical field is applied thereon in some embodiments according to the present disclosure. FIG. 2B is a diagram illustrating a light path in a light diffraction apparatus when an electrical field is applied thereon in some embodiments according to the present disclosure. Referring to FIGS. 2A and 2B, the holographic grating in some embodiments is configured to diffract a portion of the light emitted from the subpixel. As shown in FIG. 2A, only a portion of the grating element 10 includes a holographic grating, i.e., the grating element 10 includes a first portion having the holographic grating and a second portion absent of any holographic grating. Optionally, the grating element 10 is absent in a region corresponding to a light path of light emitting from the subpixel along the second direction, and the light exits the display substrate (and a display apparatus having the same) without transmitting through any grating element and without being diffracted by the grating element.

In FIG. 2A, no electrical field is applied to the grating element 10 through the first electrode 20 and the second electrode 30, light emitted from the subpixel travels through the grating element 10 along substantially the same direction. Light intensity along the first direction (leaning left) is higher than that along the second direction (leaning right). Light intensity distribution is asymmetrical between the first direction and the second direction. Brightness at a first viewing angle corresponding to the first direction is higher than brightness at a second viewing angle corresponding to the second direction, resulting in viewing angle discrepancy.

In FIG. 2B, an electrical field is applied to the grating element 10 through the first electrode 20 and the second electrode 30. As shown in FIG. 1B, a first portion of light emitted from the subpixel along a first direction (leaning left) is diffracted by the grating element 10 having the holographic grating (provided the wavelength of the light satisfies the Bragg's law is diffracted by the grating element 10). A second portion of light emitted from a same subpixel along a second direction (leaning right) exits the display substrate without being diffracted by any holographic grating. Prior to entering the grating element 10, the first portion of light emitted from the subpixel has an intensity higher than that of the second portion of light emitted from the same subpixel. As shown in FIG. 2B, the first portion of light emitted from the subpixel is diffracted into a first portion of the diffracted light transmitting substantially along the first direction and a second portion of the diffracted light transmitting substantially along the second direction. The first direction and the second direction are substantially mirror symmetrical with respect to the plane normal to the light emitting surface of the display substrate. In the light exiting from the display substrate (and a display apparatus having the same), i.e., after the first portion of light being diffracted by the grating element, the light travelling along the first direction (the first portion of the diffracted light) has a reduced intensity, and the light traveling along the second direction (a sum of the second portion of the diffracted light and the second portion of light emitted from the same subpixel) has an increased intensity. Thus, the light intensity of light travelling along the second direction is compensated by the diffraction effects of the grating element 10, resulting in a more uniform light intensity distribution between two light emitting directions.

In another aspect, the present disclosure provides a display substrate having a light diffraction apparatus described herein. The light diffraction apparatus may be made in various appropriate forms. In one example, the light diffraction apparatus is made as a film, i.e., a light diffraction film. The light diffraction film can be adhered onto a side of a display substrate, e.g., the light emitting side of the display substrate.

In some embodiments, the display substrate includes a plurality of subpixels. Optionally, the display substrate includes a plurality of sub-regions, each of which includes a plurality of subpixels. Optionally, each of the plurality of sub-regions includes a light diffraction apparatus (e.g., a light diffraction film) for diffracting light emitted from the plurality of subpixel in each sub-region. By having this design, the total number of light diffraction apparatuses (e.g., light diffraction films) required for the display substrate can be reduced. An appropriate size of the sub-region may be selected based on design needs. Optionally, each of the plurality of sub-regions has a substantially the same size and area. Optionally, each of the plurality of sub-regions includes approximately 300 subpixels. The sub-regions may have various appropriate shapes, e.g., a rectangular shape, a square shape, and the like.

In some embodiments, the strength of the electrical field applied to the grating element can be control to achieve a desired brightness at various viewing angles. Optionally, each light diffraction apparatus at each subpixel or each sub-region may be individually controlled, e.g., by controlling the strength of electrical field applied to each light diffraction apparatus at each subpixel or each sub-region.

In some embodiments, the display substrate further includes a transparent substrate (e.g., a glass substrate) on the light emitting surface, and the light diffraction apparatus is attached to the transparent substrate.

In another aspect, the present disclosure further provides a display panel having a light diffraction apparatus described herein.

In another aspect, the present disclosure further provides a display apparatus having a light diffraction apparatus described herein. Examples of appropriate display apparatuses include, but are not limited to, an electronic paper, a mobile phone, a tablet computer, a television, a monitor, a notebook computer, a digital album, a GPS, etc. Optionally, the display apparatus is a liquid crystal display apparatus. Optionally, the display apparatus is an organic light emitting display apparatus. Optionally, the display apparatus is a curved display apparatus.

In another aspect, the present disclosure further provides a touch substrate having a light diffraction apparatus described herein. The touch substrate may be attached to a light emitting side of a display panel, with the light diffraction apparatus on a side of the touch substrate proximal to the light emitting side of a display panel.

In some embodiments, the touch substrate includes a plurality of sub-regions and a plurality of light diffraction apparatuses, each of the plurality of light diffraction apparatuses being in one of the plurality of sub-regions. Each of the plurality of sub-regions corresponds to a plurality of subpixels in a display panel on which the touch substrate is to be attached. Optionally, each of the plurality of sub-regions includes a light diffraction apparatus (e.g., a light diffraction film) for diffracting light emitted from the corresponding plurality of subpixel in the display panel. By having this design, the total number of light diffraction apparatuses (e.g., light diffraction films) required for the display substrate can be reduced. An appropriate size of the sub-region may be selected based on design needs. Optionally, each of the plurality of sub-regions has a substantially the same size and area. Optionally, each of the plurality of sub-regions corresponding to approximately 300 subpixels in the display panel to be attached to the touch substrate. The sub-regions may have various appropriate shapes, e.g., a rectangular shape, a square shape, and the like.

Optionally, each sub-region of the touch substrate is a sub-touch substrate. The touch substrate includes a plurality of sub-touch substrates.

In some embodiments, the touch substrate includes a film having a light diffraction apparatus. For example, the light diffraction apparatus may be made in a form of a film to be adhered to the touch substrate. Optionally, the light diffraction film is adhered to the entire surface of the touch substrate. Optionally, the light diffraction film partially covers the surface of the touch substrate. Optionally, the touch substrate includes a plurality of sub-regions and a plurality of light diffraction apparatuses, each of the plurality of light diffraction apparatuses being in one of the plurality of sub-regions. Optionally, the touch substrate includes a plurality of sub-regions and a plurality of light diffraction apparatuses; the plurality of light diffraction apparatuses is absent in at least one of the plurality of sub-regions.

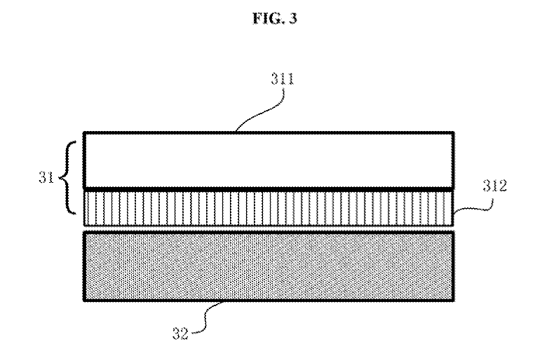

In another aspect, the present disclosure further provides a touch display apparatus having a display panel and a touch substrate, the touch substrate including a light diffraction apparatus described herein. Optionally, the light diffraction apparatus is partially integrated into the touch substrate. Optionally, the light diffraction apparatus is entirely integrated into the touch substrate. FIG. 3 is a diagram illustrating the structure of a touch display apparatus in some embodiments according to the present disclosure. Referring to FIG. 3, the touch display apparatus in some embodiments includes a display panel 32 and a touch substrate 31. The touch substrate 31 includes a first portion 311 having a touch electrode layer and a second portion 312 having a light diffraction apparatus. The second portion 312 is on a side of the touch substrate 31 proximal to the display panel 32. The second portion 312 may be a film having the light diffraction apparatus. Examples of appropriate touch display apparatuses include, but are not limited to, an electronic paper, a mobile phone, a tablet computer, a television, a monitor, a notebook computer, a digital album, a GPS, etc. Optionally, the touch display apparatus is a liquid crystal touch display apparatus. Optionally, the touch display apparatus is an organic light emitting touch display apparatus. Optionally, the touch display apparatus is a curved touch display apparatus.

In another aspect, the present disclosure further provides a method of fabricating a touch substrate. In some embodiments, the method includes forming a touch electrode layer on a base substrate; forming a photorefractive material layer on a side of the touch electrode layer distal to the base substrate; patterning (e.g., by lithography) the photorefractive material layer, forming a holographic grating in the patterned photorefractive material layer thereby forming a grating element including a photorefractive material having a holographic grating recorded thereon.

In some embodiments, the method further includes forming an electrode layer comprising a first electrode and a second electrode on a side of the touch electrode layer distal to the base substrate. Optionally, a first electrode and a second electrode are formed to be coupled to a first side and a second side of the grating element, respectively, and the first side and the second side of the grating element are substantially perpendicular to the display substrate. Optionally, a side of the first electrode facing the first side has a substantially the same dimension as the first side, and a side of the second electrode facing the second side has a substantially the same dimension as the second side.

In another aspect, the present disclosure further provides a method of modulating image display light intensity in a display panel. In some embodiments, the method includes diffracting light emitted from a subpixel of the display substrate to generate a diffracted light so that light exiting from the display panel has a more symmetrical light intensity distribution with respect to a plane normal to the light emitting surface of the display substrate as compared to the light emitted from the subpixel.

In one example, the method includes diffracting a first portion of light emitted from the subpixel along a first direction into a first portion of the diffracted light transmitting substantially along the first direction and a second portion of the diffracted light transmitting substantially along the second direction; and transmitting a second portion of light emitted from a same subpixel along a second direction without being diffracted by any holographic grating. The first portion of light emitted from the subpixel has an intensity higher than that of the second portion of light emitted from the same subpixel. Optionally, the first direction and the second direction are substantially mirror symmetrical with respect to the plane normal to the light emitting surface of the display substrate.

In another example, the method includes diffracting a first portion of light emitted from the subpixel along a first direction into a first portion of the diffracted light transmitting substantially along the first direction and a second portion of the diffracted light transmitting substantially along the second direction; and diffracting a second portion of light emitted from a same subpixel along a second direction into a third portion of the diffracted light transmitting substantially along the second direction and a fourth portion of the diffracted light transmitting substantially along the first direction. The first portion of light emitted from the subpixel has an intensity higher than that of the second portion of light emitted from the same subpixel. Optionally, the first direction and the second direction are substantially mirror symmetrical with respect to the plane normal to the light emitting surface of the display substrate.

In some embodiments, the method further includes using a light diffraction apparatus for diffract light emitted from the subpixel of the display panel. Optionally, the light diffraction apparatus includes a grating element including a photorefractive material having a holographic grating recorded thereon, configured to diffract the light emitted from a subpixel upon application of an electrical field. Optionally, the method further includes applying an electrical field to the grating element thereby modulating image display light intensity in a display panel.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A light diffraction apparatus coupled to a display substrate for diffracting light emitted from a subpixel of the display substrate, comprising a grating element comprising a photorefractive material having a holographic grating recorded thereon, configured to diffract the light emitted from the subpixel upon application of an electrical field.

2. The light diffraction apparatus of claim 1, wherein the holographic grating has a pattern configured to generate a diffracted light so that light exiting from the light diffraction apparatus has a more symmetrical light intensity distribution with respect to a plane normal to the display substrate as compared to the light emitted from the subpixel.

3. The light diffraction apparatus of claim 2, wherein the grating element having the holographic grating is configured to diffract a first portion of light emitted from the subpixel along a first direction;
a second portion of light emitted from a same subpixel along a second direction exits the display substrate without being diffracted by any holographic grating;
the first portion of light emitted from the subpixel has an intensity higher than that of the second portion of light emitted from the same subpixel;
the first portion of light emitted from the subpixel is diffracted into a first portion of the diffracted light transmitting substantially along the first direction and a second portion of the diffracted light transmitting substantially along the second direction; and
the first direction and the second direction are substantially mirror symmetrical with respect to the plane normal to the display substrate.

4. The light diffraction apparatus of claim 3, wherein the grating element comprises a first portion having the holographic grating and a second portion absent of any holographic grating; and
the second portion of light emitted from the same subpixel along the second direction transmits through the second portion of the grating element without being diffracted.

5. The light diffraction apparatus of claim 2, wherein a first portion of grating element having the holographic grating is configured to diffract a first portion of light emitted from the subpixel along a first direction;
a second portion of grating element having the holographic grating is configured to diffract a second portion of light emitted from a same subpixel along a second direction;
the first portion of light emitted from the subpixel has an intensity higher than that of the second portion of light emitted from the same subpixel;
the first portion of light emitted from the subpixel is diffracted into a first portion of the diffracted light transmitting substantially along the first direction and a second portion of the diffracted light transmitting substantially along the second direction;
the second portion of light emitted from the same subpixel is diffracted into a third portion of the diffracted light transmitting substantially along the second direction and a fourth portion of the diffracted light transmitting substantially along the first direction; and
the first direction and the second direction are substantially mirror symmetrical with respect to the plane normal to the display substrate.

6. The light diffraction apparatus of claim 1, wherein a grating periodicity Λ of the holographic grating is defined by Λ=λγ/(2n sin θγ);
n is a positive integer, λγ is a wavelength of a diffracted light, θγ is a sum of a first angle between a light incident to the grating element and a normal of an incident surface of the grating element and a second angle between the normal and a grating vector.

7. The light diffraction apparatus of claim 1, further comprising:
a first electrode and a second electrode coupled to a first side and a second side of the grating element, respectively, configured to apply the electrical field to the grating element, the first side and the second side being opposite to each other; and
a controller coupled to the first electrode and the second electrode, configured to provide a voltage signal to the first electrode and the second electrode for generating the electrical field.

8. The light diffraction apparatus of claim 7, wherein the first electrode and the second electrode are made of a transparent electrode material.

9. The light diffraction apparatus of claim 1, wherein the first side and the second side of the grating element are substantially perpendicular to the display substrate.

10. The light diffraction apparatus of claim 7, wherein a side of the first electrode facing the first side has a substantially the same dimension as the first side; and
a side of the second electrode facing the second side has a substantially the same dimension as the second side.

11. The light diffraction apparatus of claim 1, wherein a cross-section of the grating element has a square shape or a rectangular shape.

12. A display apparatus, comprising the light diffraction apparatus of claim 1.

13. A touch substrate, comprising a light diffraction apparatus of claim 1.

14. A touch apparatus, comprising
a touch substrate; and
the light diffraction apparatus of claim 1;
wherein the light diffraction apparatus is at least partially integrated into the touch substrate.

15. The touch apparatus of claim 14, wherein the touch substrate comprises a plurality of sub-regions, the light diffraction apparatus comprises a plurality of light diffraction apparatuses; and each of the plurality of light diffraction apparatuses is in one of the plurality of sub-regions.

16. A method of fabricating a touch substrate, comprising:
forming a touch electrode layer on a base substrate;
forming a photorefractive material layer on a side of the touch electrode layer distal to the base substrate;
patterning the photorefractive material layer; and
forming a holographic grating in the photorefractive material layer thereby forming a grating element comprising a photorefractive material having a holographic grating recorded thereon.

17. The method of claim 16, further comprising:
forming an electrode layer comprising a first electrode and a second electrode on a side of the touch electrode layer distal to the base substrate;
wherein the first electrode and the second electrode are formed to be coupled to a first side and a second side of the grating element, respectively;
the first side and the second side of the grating element are substantially perpendicular to the display substrate;
a side of the first electrode facing the first side has a substantially the same dimension as the first side of the grating element; and
a side of the second electrode facing the second side has a substantially the same dimension as the second side of the grating element.

18. (canceled)

19. A method of modulating image display light intensity in a display panel, comprising:
diffracting light emitted from a subpixel of the display substrate to generate a diffracted light so that light exiting from the display panel has a more symmetrical light intensity distribution with respect to a plane normal to the display substrate as compared to the light emitted from the subpixel;
diffracting a first portion of light emitted from the subpixel along a first direction into a first portion of the diffracted light transmitting substantially along the first direction and a second portion of the diffracted light transmitting substantially along the second direction;
transmitting a second portion of light emitted from a same subpixel along a second direction without being diffracted by any holographic grating;
the first portion of light emitted from the subpixel has an intensity higher than that of the second portion of light emitted from the same subpixel; and
the first direction and the second direction are substantially mirror symmetrical with respect to the plane normal to the display substrate.

20. (canceled)
